(19) United States
(12) Patent Application Publication
(10) Pub. No.: US 2026/0163747 A1
(43) Pub. Date: Jun. 11, 2026

(54) MUTUAL AUTHENTICATION METHODS, AND ASSOCIATED ELECTRONIC DEVICE, SYSTEM AND COMPUTER PROGRAMS

(71) Applicant: IDEMIA FRANCE, Courbevoie (FR)

(72) Inventors: Emmanuelle DOTTAX, Courbevoie (FR); Luk BETTALE, Courbevoie (FR)

(73) Assignee: IDEMIA FRANCE, Courbevoie (FR)

(21) Appl. No.: 19/123,817

(22) PCT Filed: Oct. 4, 2023
(86) PCT No.: PCT/EP2023/077378

§ 371 Date: Apr. 24, 2025

(30) Foreign Application Priority Data
Dec. 7, 2022 (FR) FR2212881

(51) Int. Cl. H04L 9/32; H04L 9/08

(52) U.S. Cl. CPC H04L 9/3263; H04L 9/0825

(57) ABSTRACT

A mutual authentication method is provided that is implemented by an electronic device. The method includes i) a phase of authenticating a system that includes determining and sending an authentication challenge, and then receiving a first authentication result, and then authenticating a system by applying a cryptographic signature verification function to the first authentication result, and ii) a phase of authenticating the electronic device that includes receiving an authentication datum, and then computing and sending a second authentication result, the computing of the second authentication result using a shared secret obtained by applying a decapsulation function of a key encapsulation mechanism to a private key of the electronic device and to the authentication datum.

The present invention relates to the field of computer cryptography. It relates more particularly to mutual authentication methods, and to an associated electronic device, system and computer programs.

As is known, in an asymmetric cryptography mutual authentication method, each party in the communication advertises a public key, and proves that it possesses the private key that accompanies the public key by sending a cryptographic signature made with the private key to the other party. If the signature is able to be verified with the public key, then the correct private key has been used and the party who sent the signature is legitimate.

Such a mutual authentication method is specified for example by the GSMA association in the document ‘RSP Technical Specification’, typically in version 2.3 thereof dated Jun. 30, 2021.

Such a mutual authentication method is implemented for example by an equipment of a telephony operator network and an electronic device, typically an eUICC (embedded universal integrated circuit card) secure element integrated into a communication terminal.

However, the emergence of quantum computers is making asymmetric signature mechanisms non-secure. It is therefore desirable to adapt the traditional scheme above in order to guarantee the security of the method against an attacker having a quantum computer. Some post-quantum cryptographic algorithms were proposed in the course of a competition organized by the NIST (National Institute of Standards and Technology), in particular post-quantum cryptographic signature mechanisms, and post-quantum key encapsulation mechanisms or “post-quantum KEM”.

A key encapsulation mechanism allows the secure transmission of a secret to a partner using asymmetric cryptographic algorithms.

As is known, it generally comprises two functions:
an encapsulation function, and
a decapsulation function.

Typically, a key encapsulation mechanism between two parties proposes that the first party use the public key of the other party and the encapsulation function of the key encapsulation mechanism to generate a random secret and a cipher of this secret. The cipher is transmitted to the other party, who is able, through decapsulation using their private key, to retrieve the secret thus shared.

Post-quantum signatures require phenomenal key sizes and/or phenomenal intermediate variable sizes, and therefore consume a great deal of random access memory.

Asymmetric cryptography post-quantum mutual authentication solutions, in which the authentication of each party is based on a key encapsulation mechanism and no longer on the signature of a datum received beforehand, have been proposed and may replace the above traditional mutual authentication method.

However, such solutions are not completely satisfactory since they still place too much burden on the electronic device.

To this end, the present invention relates to a method for mutual authentication between an electronic device and a system, the electronic device having a private key associated with a public key, the system having another private key associated with another public key, and the method comprising:
i) a phase of authenticating the system, comprising the following steps:
   the electronic device determining an authentication challenge, and then
   the electronic device sending the authentication challenge to the system, and then
   the system receiving the authentication challenge from the electronic device, and then
   the system computing a first authentication result on the basis of the authentication challenge and the other private key, and then
   the system sending the first authentication result to the electronic device, and then
   the electronic device receiving the first authentication result from the system, and then
   the electronic device authenticating the system, with the authentication challenge, the first authentication result and the other public key, and
ii) a phase of authenticating the electronic device, comprising the following steps:
   the system determining an authentication datum, and then
   the system sending the authentication datum to the electronic device, and then
   the electronic device receiving the authentication datum from the system, and then
   the electronic device computing a second authentication result on the basis of the authentication datum and the private key, and then
   the electronic device sending the second authentication result to the system, and then
   the system receiving the second authentication result from the electronic device, and then
   the system authenticating the electronic device with the second authentication result and the public key,
the method being characterized in that:
   the system computes the first authentication result by applying a cryptographic signature function with the other private key to a reference datum comprising the authentication challenge,
   the step of the electronic device authenticating the system is carried out by applying a cryptographic signature verification function with the other public key to the first authentication result and to the reference datum comprising the authentication challenge,
   the authentication datum and a shared secret are determined by the system by applying an encapsulation function of a key encapsulation mechanism to the public key,
   the computing of the second authentication result by the electronic device uses a shared secret obtained by applying a decapsulation function of the key encapsulation mechanism to the private key and to the authentication datum,
   the step of the system authenticating the electronic device uses the shared secret obtained by applying the encapsulation function of a key encapsulation mechanism to the public key, and the second authentication result.

The method may also comprise the optional features disclosed below for the method according to the first aspect and/or the method according to the second aspect, taken alone or in combination wherever this is technically feasible.

More particularly, what is proposed, according to a first aspect, is a method for mutual authentication between an electronic device and a system, the method being implemented by the electronic device, the electronic device having a private key associated with a public key, the system having another private key associated with another public key, and the method comprising:
i) a phase of authenticating the system, comprising the following steps:
   determining an authentication challenge, and then
   sending the authentication challenge to the system, and then
   receiving a first authentication result from the system, and then
   authenticating the system with the authentication challenge, the first authentication result and the other public key, and
ii) a phase of authenticating the electronic device, comprising the following steps:
   receiving an authentication datum from the system, and then
   computing a second authentication result on the basis of the authentication datum and the private key, and then
   sending the second authentication result to the system,
the method being characterized in that:
   the step of authenticating the system is carried out by applying a cryptographic signature verification function with the other public key to the first authentication result and to a reference datum comprising the authentication challenge,
   the computing of the second authentication result uses a shared secret obtained by applying a decapsulation function of a key encapsulation mechanism to the private key and to the authentication datum.

The method according to this first aspect may also comprise the following optional features, taken alone or in combination wherever this is technically feasible.

The private key, the public key, the other private key and the other public key are static keys, that is to say each of these keys is used for multiple iterations of the method. The private key, the public key, the other private key and the other public key are therefore not ephemeral keys, ephemeral keys being keys that are generated for a specific iteration and are valid only for that iteration.

The computing of the second authentication result comprises computing the shared secret by applying a decapsulation function of the key encapsulation mechanism to the private key and to the authentication datum, and then obtaining a derived key based on the shared secret, and then encrypting an input datum with the derived key, the second authentication result being the result of said encryption.

The computing of the second authentication result comprises computing the shared secret by applying a decapsulation function of the key encapsulation mechanism to the private key and to the authentication datum, and then obtaining a derived key based on the shared secret, and then computing an authentication code for authenticating an input datum with the derived key, the second authentication result being the computed authentication code.

The authentication challenge is an anti-replay challenge.

Each sending step and each receiving step comprises synchronous communication between the electronic device and the system.

The authentication challenge is different in each iteration of the method.

The electronic device determines the authentication challenge through a random draw or by incrementing a counter.

The reference datum is the concatenation of the authentication datum and the authentication challenge.

The derived key is obtained by applying a key derivation function to the shared secret or to the result of a concatenation of the shared secret and the authentication challenge.

A secure channel is established based on the derived key for subsequent data exchanges between the electronic device and the system.

The method furthermore comprises a step of receiving, from the system, or a step of sending, to the system, a datum that has been encrypted and/or authenticated, with at least one exchange key computed based on the derived key.

The phase of authenticating the system furthermore comprises the following steps:
receiving a certificate of the other public key from the system, and then
verifying the validity of the received certificate, and the phase of authenticating the electronic device furthermore comprises the following step:
sending a certificate of the public key to the system.

The method furthermore comprises the following steps:
receiving an ephemeral public key from the system,
obtaining another shared secret and a corresponding cipher, by applying an encapsulation function of another key encapsulation mechanism to the ephemeral public key,
obtaining another derived key based on the other shared secret,
sending the cipher corresponding to the other shared secret to the system, and:
the step of sending a certificate of the public key to the system, sending a result of an encryption of a datum comprising the certificate of the public key with the other derived key to the system, and
the step of receiving a certificate of the other public key from the system comprises decrypting a datum transmitted by the system with the other derived key.

The authentication challenge is the cipher corresponding to the other shared secret or the cipher of the datum comprising the certificate of the public key.

The other receiving steps comprise decrypting data transmitted by the system with the other derived key.

What is also proposed, according to a second aspect, is a method for mutual authentication between an electronic device and a system, the method being implemented by the system, the electronic device having a private key associated with a public key, the system having another private key associated with another public key, and the method comprising:
i) a phase of authenticating the system, comprising the following steps:
   receiving an authentication challenge from the electronic device, and then
   computing a first authentication result on the basis of the authentication challenge and the other private key, and then
   sending the first authentication result to the electronic device, and
ii) a phase of authenticating the electronic device, comprising the following steps:
   determining an authentication datum, and then
   sending the authentication datum to the electronic device, and then
   receiving a second authentication result from the electronic device, and then
   authenticating the electronic device with the second authentication result and the public key,
the method being characterized in that:
   the first authentication result is computed by applying a cryptographic signature function with the other private key to a reference datum comprising the authentication challenge,
   the authentication datum and a shared secret are determined by applying an encapsulation function of a key encapsulation mechanism to the public key,
   the step of authenticating the electronic device uses the shared secret and the second authentication result.

The method according to this second aspect may also comprise the following optional features, taken alone or in combination wherever this is technically feasible.

The private key, the public key, the other private key and the other public key are static keys, that is to say each of these keys is used for multiple iterations of the method. The private key, the public key, the other private key and the other public key are therefore not ephemeral keys, ephemeral keys being keys that are generated for a specific iteration and are valid only for that iteration.

The step of authenticating the electronic device comprises obtaining a derived key based on the shared secret, and then comparing a candidate datum and an expected datum, the candidate datum being the second authentication result and the expected datum being obtained by encrypting an input datum with the derived key, or the expected datum being an input datum and the candidate datum being obtained by decrypting the second authentication results with the derived key. The step of authenticating the electronic device comprises obtaining a derived key based on the shared secret, and then comparing a candidate datum and an expected datum, the candidate datum being the second authentication result and the expected datum being obtained by computing an authentication code for authenticating an input datum with the derived key, for example a hash-based authentication code or an encryption-based authentication code or a Galois authentication code.

The electronic device is authenticated if the candidate datum and the expected datum are identical.

Each sending step and each receiving step comprises synchronous communication between the electronic device and the system.

The authentication challenge is an anti-replay challenge.

The authentication challenge is different in each iteration of the method.

The electronic device determines the authentication challenge through a random draw or by incrementing a counter.

The reference datum is the concatenation of the authentication datum and the authentication challenge.

The derived key is obtained by applying a key derivation function to the shared secret or to the result of a concatenation of the shared secret and the authentication challenge.

A secure channel is established based on the derived key for subsequent data exchanges between the electronic device and the system.

The method furthermore comprises a step of receiving, from the electronic device, or a step of sending, to the electronic device, a datum that has been encrypted and/or authenticated, with at least one exchange key computed based on the derived key.

The phase of authenticating the system furthermore comprises the following step:
sending a certificate of the other public key to the electronic device, and the phase of authenticating the electronic device furthermore comprises the following steps:
receiving a certificate of the public key from the electronic device, and then
verifying the validity of the received certificate.

The method furthermore comprises the following steps:
sending an ephemeral public key associated with an ephemeral private key to the electronic device, and then
receiving a cipher corresponding to another shared secret from the electronic device,
obtaining the other shared secret by applying a decapsulation function of another key encapsulation mechanism to the ephemeral private key and to the received cipher,
obtaining another derived key based on the other shared secret, and wherein:
the step of receiving a certificate of the public key from the electronic device comprises decrypting a datum transmitted by the electronic device with the other derived key, and
the step of sending a certificate of the other public key to the electronic device comprises sending, to the electronic device, a result of an encryption, with the other derived key, of a datum comprising the certificate of the other public key.

The datum comprising the certificate of the other public key is the certificate of the other public key, or the result of a concatenation of the certificate of the other public key and the first authentication result, or the result of a concatenation of the certificate of the other public key and the authentication datum, or the result of a concatenation of the certificate of the other public key, the first authentication result and the authentication datum.

The authentication challenge is the cipher corresponding to the other shared secret or the datum transmitted by the electronic device.

The step of sending the first authentication result to the electronic device, and the step of sending the authentication datum to the electronic device, comprise encrypting the data to be sent with the other derived key.

What is also proposed, according to a third aspect, is a computer program comprising instructions able to be executed by a processor and designed to implement a mutual authentication method as defined above according to the first aspect when these instructions are executed by the processor.

What is also proposed, according to a fourth aspect, is a computer program comprising instructions able to be executed by a processor and designed to implement a mutual authentication method as defined above according to the second aspect when these instructions are executed by the processor.

What is also proposed, according to a fifth aspect, is an electronic device comprising means designed to implement a mutual authentication method as defined above according to the first aspect.

The invention relates in particular to an electronic device comprising a memory storing a private key associated with a public key, the electronic device being designed to cooperate with a system having another private key associated with another public key, and the electronic device furthermore comprising:
i) a first module, configured to carry out a phase of authenticating the system that comprises the following steps:
   determining an authentication challenge, and then
   sending the authentication challenge to the system, and then
   receiving a first authentication result from the system, and then
   authenticating the system with the authentication challenge, the first authentication result and the other public key, and
ii) a second module, configured to carry out a phase of authenticating the electronic device that comprises the following steps:
   receiving an authentication datum from the system, and then
   computing a second authentication result on the basis of the authentication datum and the private key, and then
   sending the second authentication result to the system, the electronic device being characterized in that:
   the first module is configured to carry out the step of authenticating the system by applying a cryptographic signature verification function with the other public key to the first authentication result and to a reference datum comprising the authentication challenge,
   the second module is configured to compute the second authentication result using a shared secret obtained by applying a decapsulation function of a key encapsulation mechanism to the private key and to the authentication datum.

This electronic device may be configured to implement each of the implementation options envisaged for the mutual authentication method as defined above according to the first aspect.

What is also proposed, according to a sixth aspect, is a system comprising means designed to implement a mutual authentication method as defined above according to the second aspect.

The invention relates in particular to a system designed to cooperate with an electronic device having a private key associated with a public key, the system comprising a memory storing another private key associated with another public key, and the system furthermore comprising:
i) a first module, configured to carry out a phase of authenticating the system that comprises the following steps:
   receiving an authentication challenge from the electronic device, and then
   computing a first authentication result on the basis of the authentication challenge and the other private key, and then
   sending the first authentication result to the electronic device, and
ii) a second module, configured to carry out a phase of authenticating the electronic device that comprises the following steps:
   determining an authentication datum, and then
   sending the authentication datum to the electronic device, and then
   receiving a second authentication result from the electronic device, and then
   authenticating the electronic device with the second authentication result and the public key,
the system being characterized in that:
   the first module is configured to compute the first authentication result by applying a cryptographic signature function with the other private key to a reference datum comprising the authentication challenge,
   the second module is configured to determine the authentication datum and a shared secret by applying an encapsulation function of a key encapsulation mechanism to the public key, and to carry out the step of authenticating the electronic device using the shared secret and the second authentication result.

This system may be configured to implement each of the implementation options envisaged for the mutual authentication method as defined above according to the second aspect.

Of course, the various features, variants and embodiments of the invention may be combined with one another in a variety of combinations provided that they are not incompatible or mutually exclusive.

Other features and advantages of the present invention will become apparent from the description given below, with reference to the appended figures, which illustrate exemplary embodiments of the invention that are completely non-limiting in nature.

### IN THE FIGURES

FIG. 1 schematically shows the main elements of an electronic device and of a system within which the invention is implemented;

FIG. 2 shows, in the form of a flowchart, the main steps of a mutual authentication method according to a first mode of implementation of the invention;

FIG. 3 shows, in the form of a flowchart, the main steps of a mutual authentication method according to a second mode of implementation of the invention.

Unless otherwise indicated, elements common to a plurality of figures or analogous elements in a plurality of figures have been designated with the same reference signs and have identical or analogous features, and hence these common elements have generally not been described more than once for the sake of simplicity.

In the context of the present description, qualifiers “first” and “second” serve only as an indication to distinguish between elements that they qualify, but do not imply an order among them.

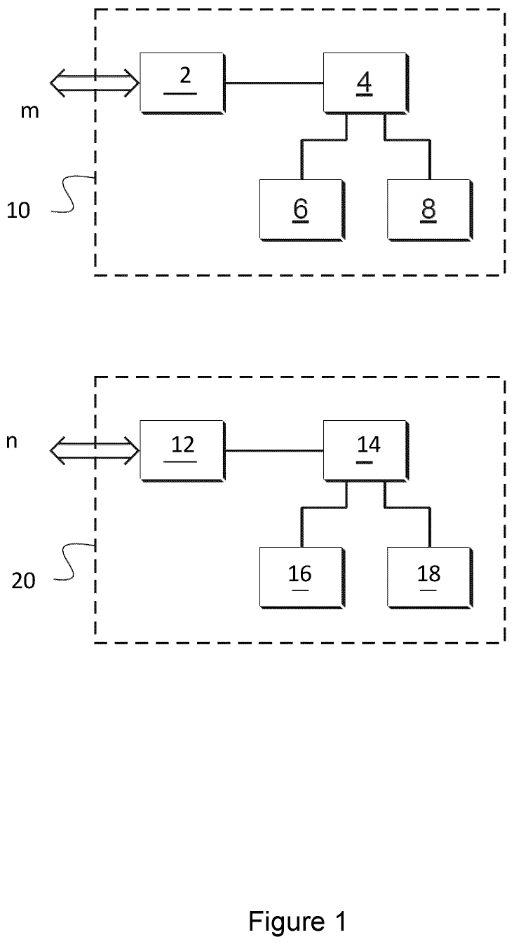

FIG. 1 schematically shows the main elements of an electronic device 10 and of a system 20 within which the invention is implemented. The electronic device 10 and the system 20 are able to cooperate, in particular in order to implement a method for mutual authentication between the electronic device 10 and the system 20.

The electronic device 10 has a private key associated with a public key (neither shown). According to a first example, the private key and the public key are RSA-KEM keys as described in the document RFC 5990: Use of the RSA-KEM Key Transport Algorithm in the Cryptographic Message Syntax (CMS), by Randall & al., dated September 2010, https://www.rfc-editor.org/rfc/rfc5990.html#appendix-A.

According to a second example, the private key and the public key are ECIES keys as described in the document BSI TR-02102-1: BSI—Technical Guideline—Cryptographic Mechanisms: Recommendations and Key Lengths, version 2022-01, dated Jan. 28, 2022, https://www.bsi.bund.de/SharedDocs/Downloads/EN/BSI/Publications/TechGuidelines/TG 02102/BSI-TR-02102-1.pdf?_blob—publicationFile.

According to a third example, the private key and the public key are Crystals-Kyber keys as described on the site Crystals Cryptographic Suite for Algebraic Lattices, https://pq-crystals.org/kyber/index.shtml.

According to a fourth example, the private key and the public key are NTRU keys as described on the site NTRU—a submission to the NIST post-quantum standardization effort, https://ntru.org/.

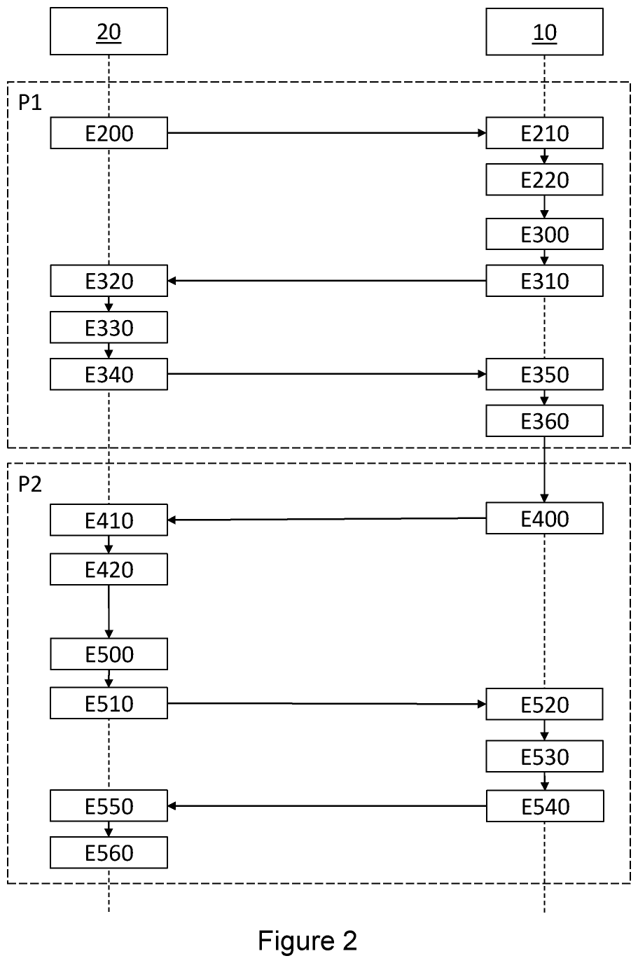

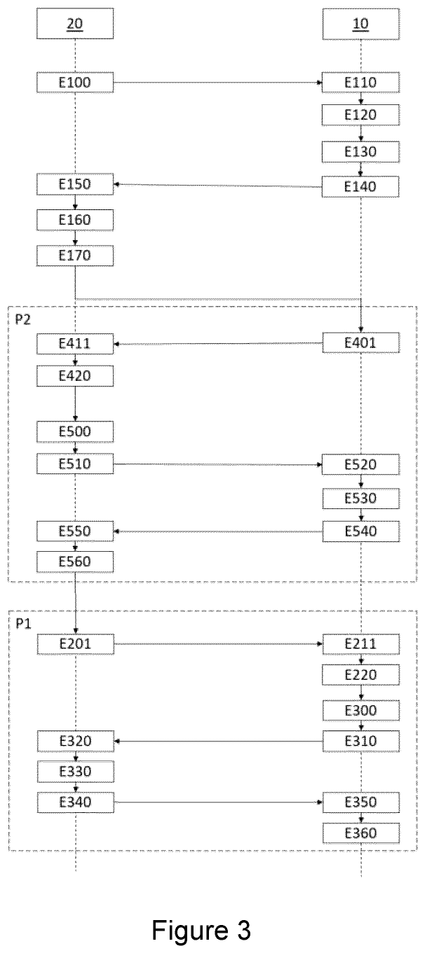

The private key and the public key are static keys, that is to say each of these keys is used to implement multiple iterations of a mutual authentication method according to the invention (typically one of the methods described with reference to FIGS. 2 and 3). The private key and the public key are therefore not ephemeral keys, ephemeral keys being keys that are generated for a specific iteration and are valid only for that iteration. The system 20 has another private key associated with another public key (neither shown).

According to a first example, the other private key and the other public key are RSA or ECDSA keys as described in the document FIPS PUB 186-4, Digital Signature Standard, by Information Technology Laboratory National Institute of Standards and Technology, and dated July 2013, https://nvlpubs.nist.gov/nistpubs/FIPS/NIST.FIPS.186-4.pdf.

According to a second example, the other private key and the other public key are Crystals-Dilithium keys as described on the site Crystals Cryptographic Suite for Algebraic Lattices, https://pq-crystals.org/dilithium/.

According to a third example, the other private key and the other public key are Falcon keys as described on the site Falcon—Fast-Fourier Lattice-based Compact Signatures over NTRU, https://falcon-sign.info/.

According to a fourth example, the other private key and the other public key are Sphincs+keys as described on the site Sphincs+Stateless hash-based signatures, https://sphincs.org/.

According to a fifth example, the other private key and the other public key are LMS or XMSS keys as described in the document NIST SP 800-208, Recommendation for stateful Hash-Based signature Schemes, by National Institute of Standards and Technology, and dated October 2020, https://nvlpubs.nist.gov/nistpubs/SpecialPublications/NIST.SP.800-208.pdf.

It should be noted that the private key and the public key may be of a different type than the other private key and the other public key.

For example, the private key and the public key may be NTRU keys, whereas the other private key and the other public key are Crystals-Kyber keys.

The other private key and the other public key are static keys, that is to say each of these keys is used to implement multiple iterations of a mutual authentication method according to the invention (typically one of the methods described with reference to FIGS. 2 and 3). The other private key and the other public key are therefore not ephemeral keys, ephemeral keys being keys that are generated for a specific iteration and are valid only for that iteration.

FIG. 1 thus schematically shows an electronic device 10 comprising a processor 4 (for example a microprocessor), a storage unit 6, a random access memory 8 and a communication unit 2.

The random access memory 8 and the storage unit 6 are each linked to the processor 4 such that the processor 4 is able to read or write data from or to the storage unit 6 and/or the random access memory 8.

The storage unit 6 stores computer program instructions, some of which are designed to implement a mutual authentication method such as at least one of those described with reference to FIGS. 2 and 3, in particular in cooperation with the system 20, when these instructions are executed by the processor 4.

The storage unit 6 is for example, in practice, a hard drive or a non-volatile memory that is possibly rewritable, for example an EEPROM (electrically erasable and programmable read-only memory).

The random access memory 8 may for its part store at least some of the elements (in particular an authentication challenge, an authentication datum, a first authentication result and/or a second authentication result as described below with reference to FIGS. 2 and 3) handled during the various processing operations carried out in the course of at least one of the methods described below.

Furthermore, the storage unit 6 and/or the random access memory 8 may store the private key and/or the public key and/or a certificate of the public key.

In the remainder of the description, either one of the storage unit 6 and the random access memory 8 will be referred to as a memory.

The electronic device 10 also comprises multiple modules that are not shown.

Typically, the electronic device 10 comprises a first module configured to carry out a phase of authenticating the system 20, and a second module configured to carry out a phase of authenticating the electronic device 10. The electronic device 10 may also comprise a third module for confidentiality.

These modules may in practice be formed by a combination of hardware elements and software elements.

Each module out of the first module and the second module is configured to carry out the steps of a phase described in the methods according to the invention and disclosed below, and therefore has a functionality described in the methods according to the invention and disclosed below.

The third module for confidentiality is configured to carry out other steps described with reference to FIG. 3.

Thus, for each module, the electronic device 10 stores for example software instructions able to be executed by the processor 4 in order to use a hardware element (for example a communication unit or a memory) and thus implement the functionality offered by the module.

According to one implementation option, the computer program instructions stored in the storage unit 6 were received (for example from a remote computer) during an operating phase of the electronic device 10 prior to the methods described with reference to FIGS. 2 and 3.

The communication unit 2 is connected to the processor 4 so as to allow the processor 4 to receive data m from the system 20, for example a first authentication result and an authentication datum as described with reference to FIGS. 2 and 3, and/or to transmit data m to the system 20, for example an authentication challenge and a second authentication result as described with reference to FIGS. 2 and 3.

The electronic device may take numerous forms (that are not shown).

According to a first example, the electronic device is a chip card, such as an identity card, a bank card or a universal integrated circuit card (also known as a UICC).

According to a second example, the electronic device is a secure element, such as a secure microcontroller that is integrated into another electronic device, typically a communication terminal or a car.

According to other examples, the electronic device is a USB key, or an identity document, such as an electronic passport.

FIG. 1 also schematically shows the system 20.

The system 20 comprises a processor 14 (for example a microprocessor), a storage unit 16, a random access memory 18 and a communication unit 12.

The random access memory 18 and the storage unit 16 are each linked to the processor 14 such that the processor 14 is able to read or write data from or to the storage unit 16 and/or the random access memory 18.

The storage unit 16 stores computer program instructions, some of which are designed to implement a mutual authentication method such as at least one of those described with reference to FIGS. 2 and 3, in particular in cooperation with the electronic device 10, when these instructions are executed by the processor 14.

The storage unit 16 is for example, in practice, a hard drive or a non-volatile memory that is possibly rewritable, for example an EEPROM (electrically erasable and programmable read-only memory).

The random access memory 18 may for its part store at least some of the elements (in particular an authentication challenge, an authentication datum, a first authentication result and/or a second authentication result as described below with reference to FIGS. 2 and 3) handled during the various processing operations carried out in the course of at least one of the methods described below.

Furthermore, the storage unit 16 and/or the random access memory 18 may store the other private key and/or the other public key and/or a certificate of the other public key. In the remainder of the description, either one of the storage unit 16 and the random access memory 18 will be referred to as a memory.

The system 20 also comprises multiple modules that are not shown.

Typically, the system 20 comprises a first module configured to carry out a phase of authenticating the system 20, and a second module configured to carry out a phase of authenticating the electronic device 10. The system 20 may also comprise a third module for confidentiality.

These modules may in practice be formed by a combination of hardware elements and software elements. Each module out of the first module and the second module is configured to carry out the steps of a phase described in the methods according to the invention and disclosed below, and therefore has a functionality described in the methods according to the invention and disclosed below.

The third module for confidentiality is configured to carry out other steps described with reference to FIG. 3.

Thus, for each module, the system 20 stores for example software instructions able to be executed by the processor 14 in order to use a hardware element (for example a communication unit or a memory) and thus implement the functionality offered by the module. According to one implementation option, the computer program instructions stored in the storage unit 16 were received (for example from a remote computer) during an operating phase of the system 20 prior to the methods described with reference to FIGS. 2 and 3.

The communication unit 12 is connected to the processor 14 so as to allow the processor 14 to receive data n from the electronic device 10, for example an authentication challenge and a second authentication result as described with reference to FIGS. 2 and 3, and/or to transmit data n to the electronic device 10, for example a first authentication result and an authentication datum as described with reference to FIGS. 2 and 3.

The system may take numerous forms (that are not shown), such as a server, a communication terminal, a computer or an electronic equipment of a telecommunications network.

FIG. 2 shows, in the form of a flowchart, the main steps of a mutual authentication method according to a first mode of implementation of the invention.

This method is implemented by the electronic device 10, the electronic device 10 having a private key associated with a public key and cooperating with the system 20, and by the system 20, the system 20 having another private key associated with another public key and cooperating with the electronic device 10.

Typically, the electronic device 10 has the private key in at least one of its memories, and the system 20 has the other private key in at least one of its memories.

Furthermore, the electronic device 10 may have the public key in at least one of its memories, and the system 20 may have the other public key in at least one of its memories.

In a step of sending a certificate to the electronic device (step E200), the system 20 sends a certificate of the other public key to the electronic device 10, typically using its communication unit 12.

In a step of receiving a certificate from the system (step E210), the electronic device 10 receives the certificate of the other public key from the system 20, typically using its communication unit 2.

The method then comprises a certificate verification step (step E220) during which the electronic device 10 verifies the validity of the received certificate of the other public key.

The security of the mutual authentication method is thus enhanced.

The method allows the electronic device to ensure that the other public key and the other private key were issued by an entity validated by a trusted authority. The electronic device may thus associate the other public key with the system and ensure the validity of said other public key.

The certificate of the other public key may consist of the concatenation of the other public key and a cryptographic signature of said other public key, for example made with a private certification key issued by a trusted authority. As an alternative, the certificate of the other public key may consist of a certificate chain, one of the certificates of which comprises the concatenation of the other public key and a cryptographic signature of said other public key, for example made with an intermediate private certification key issued by an intermediate authority, the intermediate authority being validated by a trusted authority via said certificate chain.

The electronic device 10 may then verify the received certificate of the other public key by verifying said signature with a public certification key associated with the private certification key.

Typically, the electronic device 10 has the public certification key, for example in one of its memories.

According to one implementation option, the electronic device 10 has received the public certification key beforehand (for example from a remote computer) during an operating phase of the electronic device 10 prior to the method described here.

In a step of determining an authentication challenge (step E300), the electronic device 10 determines an authentication challenge.

The authentication challenge is a datum based on which the system 20 will compute a response with the other private key.

In the method of the invention, the authentication challenge is not a cryptographic key, and is not used as such.

The method limits burdening of the resources of the electronic device.

Preferably, the authentication challenge is an anti-replay challenge.

Typically, the authentication challenge is different in each iteration of the method. For example, the electronic device may determine the authentication challenge through a random draw or by incrementing a counter.

The method thus secures mutual authentication against replay attacks while limiting the processing operations implemented by the electronic device.

The method then comprises a step of sending the authentication challenge to the system (step E 310), during which the electronic device 10 sends the authentication challenge to the system 20, typically using its communication unit 2.

The method then comprises a step of receiving the authentication challenge from the electronic device (step E 320), during which the system 20 receives the authentication challenge from the electronic device, typically using its communication unit 12.

The method then comprises a step of computing a first authentication result (step E330), during which the system 20 computes said first authentication result on the basis of the authentication challenge and the other private key. The system 20 computes the first authentication result by applying a cryptographic signature function with the other private key to a reference datum comprising the authentication challenge. The first result is thus typically a signature of the reference datum with the other private key.

The reference datum is determined by the system based on the authentication challenge received from the electronic device.

Some examples of signature functions are described in the references cited above for the examples of the other private key and the other public key.

Typically, if the other private key and the other public key are Crystals-Dilithium keys as described on the site Crystals—Cryptographic Suite for Algebraic Lattices, https://pq-crystals.org/dilithium/, the signature function is as described in that document.

The method implemented by the system thus invokes a cryptographic signature function rather than a decapsulation function of a key encapsulation mechanism to authenticate the system.

The method then comprises a step of sending the first authentication result to the electronic device (step E340), during which the system 20 sends the first authentication result to the electronic device 10, typically using its communication unit 12.

The method then comprises a step of receiving the first authentication result from the system (step E350), during which the electronic device 10 receives the first authentication result from the system 20, typically using its communication unit 2.

The method then comprises a step of authenticating the system (step E360), during which the electronic device 10 authenticates the system 20 with the authentication challenge, the first authentication result and the other public key. The electronic device 10 authenticates the system 20 by applying a cryptographic signature verification function with the other public key to the first authentication result and to another reference datum comprising the authentication challenge.

The other reference datum is determined by the electronic device based on the authentication challenge sent to the system.

The reference datum and the other reference datum must be determined, respectively, using a similar algorithm, by the system 20 and the electronic device 10.

For example, when the reference datum is the authentication challenge received by the system from the electronic device, the other reference datum is the authentication challenge sent to the system by the electronic device.

The cryptographic signature verification function is a cryptographic function associated with the signature function used by the system during the step of computing a first authentication result (step E330).

The method implemented by the electronic device thus invokes a cryptographic signature verification function rather than an encapsulation function of a key encapsulation mechanism to authenticate the system.

The method thus limits burdening of the resources of the electronic device.

The step of sending a certificate to the electronic device (step E200), the step of receiving a certificate from the system (step E210), the certificate verification step (step E220), the step of determining an authentication challenge (step E300), the step of sending the authentication challenge to the system (step E310), the step of receiving the authentication challenge from the electronic device (step E320), the step of computing a first authentication result (step E330), the step of sending the first authentication result to the electronic device (step E340), the step of receiving the first authentication result from the system (step E350) and the step of authenticating the system (step E360) are in a phase of authenticating the system (phase P1).

This phase of authenticating the system is typically implemented by the first module of the system 20 and the first module of the electronic device 10.

The first module of the system 20 may thus implement the step of sending a certificate to the electronic device (step E200), the step of receiving the authentication challenge from the electronic device (step E320), the step of computing a first authentication result (step E330) and the step of sending the first authentication result to the electronic device (step E340).

The first module of the electronic device 10 may implement the step of receiving a certificate from the system (step E210), the certificate verification step (step E220), the step of determining an authentication challenge (step E300), the step of sending the authentication challenge to the system (step E310), the step of receiving the first authentication result from the system (step E350) and the step of authenticating the system (step E360).

In a step of sending a certificate to the system (step E400), the electronic device 10 sends a certificate of the public key to the system 20, typically using its communication unit 2.

In a step of receiving a certificate from the electronic device (step E410), the system 20 receives the certificate of the public key from the electronic device 10, typically using its communication unit 12.

The method then comprises another certificate verification step (step E420) during which the system 20 verifies the validity of the received certificate of the public key.

The security of the mutual authentication method is thus enhanced.

The method allows the system to ensure that the public key and the private key were issued by an entity validated by a trusted authority. The system may thus associate the public key with the electronic device and ensure the validity of said public key.

The certificate of the public key may consist of the concatenation of the public key and a cryptographic signature of said public key, for example made with another private certification key issued by a trusted authority. As an alternative, the certificate of the public key may consist of a certificate chain, one of the certificates of which comprises the concatenation of the public key and a cryptographic signature of said public key, for example made with another intermediate private certification key issued by an intermediate authority, the intermediate authority being validated by a trusted authority via said certificate chain.

The system 20 may then verify the received certificate of the public key by verifying said signature with another public certification key associated with the other private certification key.

Typically, the system 20 has the other public certification key, for example in one of its memories.

According to one implementation option, the system 20 has received the other public certification key beforehand (for example from a remote computer) during an operating phase of the system 20 prior to the method described here.

The other public certification key and the other private certification key may be the public certification key and the private certification key described above, respectively.

In a step of determining an authentication datum (step E500), the system 20 determines an authentication datum and a shared secret by applying an encapsulation function of a key encapsulation mechanism to the public key. The authentication datum is the cipher of the shared secret.

Some examples of encapsulation functions of encapsulation mechanisms are described in the references cited above for the examples of the private key and the public key.

Typically, if the private key and the public key are RSA-KEM keys as described in the document RFC 5990: Use of the RSA-KEM Key Transport Algorithm in the Cryptographic Message Syntax (CMS), by Randall & al., dated September 2010, https://www.rfc-editor.org/rfc/rfc5990.html#appendix-A, the encapsulation function of the encapsulation mechanism is as described in that document.

The method implemented by the system thus invokes an encapsulation function of a key encapsulation mechanism rather than a cryptographic signature verification function to authenticate the electronic device.

The method then comprises a step of sending the authentication datum to the electronic device (step E510), during which the system 20 sends the authentication datum to the electronic device 10, typically using its communication unit 12.

The method then comprises a step of receiving the authentication datum (step E520), during which the electronic device 10 receives the authentication datum from the system 20, typically using its communication unit 2.

The method then comprises a step of computing a second authentication result (step E530), during which the electronic device 10 computes a second authentication result on the basis of the authentication datum and the private key. The electronic device 10 computes the second authentication result using a shared secret obtained by applying a decapsulation function of the key encapsulation mechanism to the private key and to the authentication datum.

Some examples of decapsulation functions of encapsulation mechanisms are described in the references cited above for the examples of the private key and the public key.

Typically, if the private key and the public key are RSA-KEM keys as described in the document RFC 5990: Use of the RSA-KEM Key Transport Algorithm in the Cryptographic Message Syntax (CMS), by Randall & al., dated September 2010, https://www.rfc-editor.org/rfc/rfc5990.html#appendix-A, the decapsulation function of the encapsulation mechanism is as described in that document.

According to a first option, the computing of the second authentication result comprises computing the shared secret by applying a decapsulation function of the key encapsulation mechanism to the private key and to the authentication datum, and then obtaining a derived key based on the shared secret, and then encrypting an input datum with the derived key, the second authentication result being the result of said encryption. The derived key is used here as encryption key.

The derived key may be obtained by applying a key derivation function from the prior art to the shared secret or to the result of a concatenation of the shared secret and the authentication challenge.

According to another example, the derived key is the shared secret.

The shared secret allows the system to introduce a random element into the computing of the derived key in each iteration of the method.

The authentication challenge allows the electronic device to also introduce a random element into the computing of the derived key.

According to a second option, the computing of the second authentication result comprises computing the shared secret by applying a decapsulation function of the key encapsulation mechanism to the private key and to the authentication datum, and then obtaining a derived key based on the shared secret, and then computing an authentication code for authenticating an input datum with the derived key, for example a hash-based authentication code as proposed in the publication FIPS PUB198-1 “The Keyed-Hash Message Authentication Code” by NIST and dated July 2008, or an encryption-based authentication code as proposed in the publication NIST.SP.800-38B “Recommendation for Block Cipher Modes of Operation: The CMAC Mode for Authentication” by NIST and dated May 2005, or a Galois authentication code as proposed in the publication NIST.SP.800-38D “Recommendation for Block Cipher Modes of Operation: Galois/Counter Mode (GCM) and GMAC” by NIST and dated November 2007. The second authentication result is then the computed authentication code. The derived key is used here as key for computing the authentication code for authenticating the input datum.

In the same way as the first option, the derived key may be obtained by applying a key derivation function from the prior art to the shared secret or to the result of a concatenation of the shared secret and the authentication challenge.

Still in the same way as the first option, the derived key may, according to another example, be the shared secret.

The shared secret allows the system to introduce a random element into the computing of the derived key in each iteration of the method.

The authentication challenge allows the electronic device to also introduce a random element into the computing of the derived key.

The method implemented by the electronic device thus invokes a decapsulation function of a key encapsulation mechanism rather than a cryptographic signature function to authenticate the electronic device.

The method thus limits burdening of the resources of the electronic device.

The method then comprises a step of sending the second authentication result to the system (step E540), during which the electronic device 10 sends the second authentication result to the system 20, typically using its communication unit 2.

The method then comprises a step of receiving a second authentication result from the electronic device (step E550), during which the system 20 receives the second authentication result from the electronic device 10, typically using its communication unit 12.

The method then comprises a step of authenticating the electronic device 10 (step E560), during which the system 20 authenticates the electronic device 10 with the second authentication result and the public key. The system authenticates the electronic device using the shared secret (which was determined by the system 20 based on the public key during the step of determining an authentication datum, that is to say during step E500) and the second authentication result.

When the step of computing a second authentication result (step E530) is implemented according to the first option described above for this step, the step of authenticating the electronic device comprises obtaining the derived key based on the shared secret, and then comparing a candidate datum and an expected datum. The electronic device is authenticated if the candidate datum and the expected datum are identical.

The candidate datum is the second authentication result and the expected datum is obtained by encrypting the input datum with the derived key, or the expected datum is the input datum and the candidate datum is obtained by decrypting the second authentication result with the derived key. The derived key is used as encryption or decryption key.

The input datum may be any datum known to the system 20 and to the electronic device 10, for example the authentication challenge, the authentication datum, the result of a concatenation of the authentication challenge and the authentication datum, or another datum received beforehand by the system 20 and the electronic device 10, typically during an operating phase of the electronic device 10 and of the system 20 prior to the method described here.

The encryption or decryption operation executed here by the system 20 is in accordance with a cryptographic algorithm, for example AES, associated with the encryption operation executed by the electronic device 10 during the step of computing a second authentication result (step E530).

Furthermore, the derived key is obtained by the system 20 in a manner similar to how it is obtained by the electronic device 10.

According to a first example, when the electronic device obtains the derived key by applying a key derivation function from the prior art to the shared secret determined during the step of computing a second authentication result (step E530), the system computes the derived key by applying this derivation function to the shared secret determined during the step of determining an authentication datum (step E500).

According to a second example, when the electronic device obtains the derived key by applying a key derivation function from the prior art to the result of a concatenation of the shared secret and the authentication challenge, the shared secret having been determined during the step of computing a second authentication result (step E530) and the authentication challenge having been determined during the step of determining an authentication challenge (step E300), the system computes the derived key by applying this derivation function to the result of another concatenation of the shared secret and the authentication challenge, the shared secret having been determined during the step of determining an authentication datum (step E500) and the authentication challenge having been received during the step of receiving the authentication challenge from the electronic device (step E320).

According to a third example, when the derived key obtained by the electronic device is the shared secret determined during the step of computing a second authentication result (step E530), the derived key computed by the system is the shared secret determined during the step of determining an authentication datum (step E500).

When the step of computing a second authentication result (step E530) is implemented according to the second option described above for this step, the step of authenticating the electronic device comprises obtaining the derived key based on the shared secret, and then comparing a candidate datum and an expected datum, the candidate datum being the second authentication result and the expected datum being obtained by computing the authentication code for authenticating the input datum with the derived key. The derived key is used as key for computing the authentication code for authenticating the input datum. The electronic device is authenticated if the candidate datum and the expected datum are identical.

The input datum may be any datum known to the system 20 and to the electronic device 10, for example the authentication challenge, the authentication datum, the result of a concatenation of the authentication challenge and the authentication datum, or another datum received beforehand by the system 20 and the electronic device 10, typically during an operating phase of the electronic device 10 and of the system 20 prior to the method described here.

The authentication code is obtained by the system 20 in a manner similar to how it is obtained by the electronic device 10.

For example, when the electronic device 10 determines an authentication code as proposed in the publication FIPS PUB198-1 “The Keyed-Hash Message Authentication Code” by NIST and dated July 2008, the system 20 also determines the authentication code as proposed in that publication.

Furthermore, like in the case of the first option, the derived key is obtained by the system 20 in a similar manner to how it is obtained by the electronic device 10.

The step of sending a certificate to the system (step E400), the step of receiving a certificate from the electronic device (step E410), the other certificate verification step (step E420), the step of determining an authentication datum (step E500), the step of sending the authentication datum to the electronic device (step E510), the step of receiving the authentication datum (step E520), the step of computing a second authentication result (step E530), the step of sending the second authentication result to the system (step E540), the step of receiving a second authentication result from the electronic device (step E550) and the step of authenticating the electronic device (step E560) are in a phase of authenticating the electronic device (phase P2).

This phase of authenticating the electronic device is typically implemented by the second module of the system 20 and the second module of the electronic device 10.

The second module of the system 20 may thus implement the step of receiving a certificate from the electronic device (step E410), the other certificate verification step (step E420), the step of determining an authentication datum (step E500), the step of sending the authentication datum to the electronic device (step E510), the step of receiving a second authentication result from the electronic device (step E550) and the step of authenticating the electronic device (step E560).

The second module of the electronic device 10 may implement the step of sending a certificate to the system (step E400), the step of receiving the authentication datum (step E520), the step of computing a second authentication result (step E530) and the step of sending the second authentication result to the system (step E540).

The method limits burdening of the resources of the electronic device.

The method implemented by the electronic device invokes a decapsulation function of a key encapsulation mechanism rather than a cryptographic signature function to authenticate the electronic device, and a cryptographic signature verification function rather than an encapsulation function of a key encapsulation mechanism to authenticate the system.

The method implemented by the system invokes a cryptographic signature function rather than a decapsulation function of a key encapsulation mechanism to authenticate the system, and an encapsulation function of a key encapsulation mechanism rather than a cryptographic signature verification function to authenticate the electronic device.

The method implemented by the system thus allows the electronic device to invoke a decapsulation function of a key encapsulation mechanism rather than a cryptographic signature function to authenticate the electronic device, and a cryptographic signature verification function rather than an encapsulation function of a key encapsulation mechanism to authenticate the system.

The method is particularly suitable for mutual authentication between the electronic device and the system in the context of synchronous communication between said electronic device and said system.

Thus, in one particular mode of implementation, each sending step (typically sending the authentication challenge to the system, sending a certificate to the system and sending the second authentication result to the system) and each receiving step (typically receiving a certificate from the system, receiving the first authentication result from the system and receiving the authentication datum) implemented by the electronic device comprises synchronous communication between the electronic device and the system.

In this particular mode of implementation, each sending step (typically sending a certificate to the electronic device, sending the first authentication result to the electronic device and sending the authentication datum to the electronic device) and each receiving step (typically receiving the authentication challenge from the electronic device, receiving a certificate from the electronic device and receiving a second authentication result from the electronic device) implemented by the system comprises synchronous communication between the electronic device and the system.

Each exchange between the electronic device 10 and the system 20 is thus direct and instantaneous.

The method then allows mutual authentication through synchronous communication while limiting the processing operations implemented by the electronic device.

Advantageously, a secure channel may be established based on the derived key for subsequent data exchanges between the electronic device and the system.

The method may then furthermore comprise a step of receiving, from the electronic device, or a step of sending, to the electronic device (neither shown), respectively a step of sending, to the system, and a step of receiving, from the system (neither shown), a datum that has been encrypted and/or authenticated, with at least one exchange key computed based on the derived key.

A person skilled in the art will understand that the steps of this method may be executed in other orders, provided that each step has the elements (for example the public key, the other public key, the authentication challenge, the first authentication result, the authentication datum or the second authentication result) needed for it to be executed.

The steps of this method may thus be executed in other orders, provided that
for each step implemented by the electronic device 10, said electronic device has the elements needed to execute the step in question, and
for each step implemented by the system 20, said system has the elements needed to execute the step in question.

According to a first example, the steps of the phase of authenticating the electronic device (phase P2) may be executed before the steps of the phase of authenticating the system (phase P1).

Typically, the step of sending a certificate to the system (step E400), the step of receiving a certificate from the electronic device (step E410), the other certificate verification step (step E420), the step of determining an authentication datum (step E500), the step of sending the authentication datum to the electronic device (step E510), the step of receiving the authentication datum (step E520), the step of computing a second authentication result (step E530), the step of sending the second authentication result to the system (step E540), the step of receiving a second authentication result from the electronic device (step E550) and the step of authenticating the electronic device (step E560) may be executed, for example in that order, before the execution of the step of sending a certificate to the electronic device (step E200), the step of receiving a certificate from the system (step E210), the certificate verification step (step E220), the step of determining an authentication challenge (step E300), the step of sending the authentication challenge to the system (step E310), the step of receiving the authentication challenge from the electronic device (step E320), the step of computing a first authentication result (step E330), the step of sending the first authentication result to the electronic device (step E340), the step of receiving the first authentication result from the system (step E350) and the step of authenticating the system (step E360), for example in that order.

According to a second example, the execution of the steps of the phase of authenticating the electronic device (phase P2) and the steps of the phase of authenticating the system (phase P1) may be interleaved, the phase of authenticating the electronic device and the phase of authenticating the system thus taking place concomitantly.

Typically, the steps of the method may be executed in the following order:
determining an authentication challenge (step E300), and then
sending a certificate to the system (step E400) and sending the authentication challenge to the system (step E310), and then
receiving a certificate from the electronic device (step E410) and receiving the authentication challenge from the electronic device (step E320), and then
carrying out certificate verification (step E420), and then
determining an authentication datum (step E500) and computing a first authentication result (step E330), and then
sending a certificate to the electronic device (step E200), sending the first authentication result to the electronic device (step E340) and sending the authentication datum to the electronic device (step E510), and then
receiving a certificate from the system (step E210), receiving the first authentication result from the system (step E350) and receiving the authentication datum (step E520), and then
carrying out certificate verification (step E220), and then
authenticating the system (step E360), and then
computing a second authentication result (step E530), and then
sending the second authentication result to the system (step E540), and then
receiving the second authentication result from the electronic device (step E550), and then
authenticating the electronic device (step E560).

Advantageously, the steps of sending a certificate to the system (step E400) and sending the authentication challenge to the system (step E310), respectively receiving a certificate from the electronic device (step E410) and receiving the authentication challenge from the electronic device (step E320), may be executed simultaneously by grouping the certificate of the public key and the authentication challenge in a single message that is sent by the electronic device to the system.

Furthermore, advantageously, the steps of sending a certificate to the electronic device (step E200) and sending the first authentication result to the electronic device (step E340) and sending the authentication datum to the electronic device (step E510), respectively receiving a certificate from the system (step E210) and receiving the first authentication result from the system (step E350) and receiving the authentication datum (step E520), may be executed simultaneously by grouping the certificate of the other public key, the first authentication result and the authentication datum in a single other message that is sent by the system to the electronic device.

The first module and the second module of the electronic device 10 may therefore cooperate to implement steps of the method.

Similarly, the first module and the second module of the system 20 may therefore cooperate to implement steps of the method.

Finally, in particular when the steps are ordered as described above for the second example, the reference datum may be the concatenation of the authentication datum (computed by the system during the step of determining an authentication datum) and the authentication challenge (received from the electronic device). The other reference datum is then the concatenation of the authentication datum (received from the system) and the authentication challenge (determined by the electronic device and sent to the system).

The phase of authenticating the electronic device and the phase of authenticating the system are thus cryptographically linked. The security of the mutual authentication method is thus enhanced.

A person skilled in the art will also understand that some steps of this method may be omitted, provided that the other steps have the elements needed to execute them.

According to a first example, the step of sending a certificate to the electronic device (step E200), the step of receiving a certificate from the system (step E210) and the certificate verification step (step E 220) may be omitted when the electronic device 10 already has the other public key, typically when the electronic device 10 has received the other public key beforehand (for example from a remote computer or from the system 20) during an operating phase of the electronic device 10 prior to the method described here.

According to a second example, the step of sending a certificate to the system (step E400), the step of receiving a certificate from the electronic device (step E410) and the other certificate verification step (step E 420) may be omitted when the system 20 already has the public key, typically when the system 20 has received the public key beforehand (for example from a remote computer or from the electronic device 10) during an operating phase of the system 20 prior to the method described here.

FIG. 3 shows, in the form of a flowchart, the main steps of a mutual authentication method according to a second mode of implementation of the invention.

This method is implemented by the electronic device 10, the electronic device 10 having a private key associated with a public key and cooperating with the system 20, and by the system 20, the system 20 having another private key associated with another public key and cooperating with the electronic device 10.

Typically, the electronic device 10 has the private key in at least one of its memories, and the system 20 has the other private key in at least one of its memories.

Furthermore, the electronic device 10 has a certificate of the public key in at least one of its memories, and the system 20 has a certificate of the other public key in at least one of its memories.

In a step of sending an ephemeral public key to the electronic device (step E100), the system 20 sends an ephemeral public key associated with an ephemeral private key to the electronic device 10, typically using its communication unit 12.

The system 20 has the ephemeral public key and the ephemeral private key, typically in one of its memories.

According to one implementation option, the system 20 has received the ephemeral public key and the ephemeral private key beforehand (for example from a remote computer) during an operating phase of the system 20 prior to the method described here.

According to another implementation option, the system 20 has determined the ephemeral public key and the ephemeral private key beforehand during a step (not shown) of determining ephemeral keys.

According to a first example, the ephemeral public key and the ephemeral private key are ECIES keys as described in the document BSI TR-02102-1: BSI—Technical Guideline, version 2022-01, dated Jan. 28, 2022, https://www.bsi.bund.de/SharedDocs/Downloads/EN/BSI/Publications/TechGuide-lines/TG02102/BSI-TR-02102-1.pdf? _blob=publicationFile.

According to a second example, the ephemeral public key and the ephemeral private key are Crystals-Kyber keys as described on the site Crystals—Cryptographic Suite for Algebraic Lattices, https://pq-crystals.org/kyber/index.shtml.

According to a third example, the ephemeral public key and the ephemeral private key are NTRU keys as described on the site NTRU—a submission to the NIST post-quantum standardization effort, https://ntru.org/.

The method then comprises a step of receiving the ephemeral public key from the system (step E 110), during which the electronic device 10 receives the ephemeral public key from the system 20, typically using its communication unit 2.

The method then comprises a step of obtaining another shared secret, that is to say a shared secret different from the shared secret obtained and used during the phase of authenticating the electronic device (see below), and a corresponding cipher (step E120), during which the electronic device 10 obtains said other shared secret and said corresponding cipher by applying an encapsulation function of another key encapsulation mechanism to the ephemeral public key, that is to say a key encapsulation mechanism that may be different from the encapsulation mechanism used during the phase of authenticating the electronic device (see below).

Some examples of encapsulation functions of the other encapsulation mechanism are described in the references cited above for the examples of the ephemeral public key and the ephemeral private key.

Typically, if the ephemeral public key and the ephemeral private key are ECIES keys as described in the document BSI TR-02102-1: BSI—Technical Guideline, version 2022-01, dated Jan. 28, 2022, https://www.bsi.bund.de/SharedDocs/Downloads/EN/BSI/Publications/TechGuidelines/TG 02102/BSI-TR-02102-1.pdf? blob=publicationFile, the encapsulation function of the other encapsulation mechanism is as described in that document.

The ephemeral public key allows the system to introduce a random element that forces the use of a new, other shared secret in each iteration of the method.

The application of the encapsulation function of the other key encapsulation mechanism allows the electronic device to introduce a random element that also forces the use of a new, other shared secret in each iteration of the method.

The method then comprises a step of obtaining another derived key (step E130), that is to say a derived key different from the derived key obtained and used during the phase of authenticating the electronic device (see below), during which the electronic device 10 obtains said other derived key based on the other shared secret.

The other derived key may be obtained by applying a key derivation function from the prior art to the other shared secret.

According to another option, the other derived key is the other shared secret.

The method then comprises a step of sending the cipher corresponding to the other shared secret to the system (step E140), during which the electronic device 10 sends the cipher corresponding to the other shared secret to the system 20, typically using its communication unit 2.

The method then comprises a step of receiving the cipher corresponding to the other shared secret from the electronic device (step E150), during which the system 20 receives the cipher corresponding to the other shared secret from the electronic device 10, typically using its communication unit 12.

The method then comprises a step of obtaining the other shared secret (step E160), during which the system 20 obtains the other shared secret by applying a decapsulation function of the other key encapsulation mechanism to the ephemeral private key and to the cipher received during the step of receiving the cipher corresponding to the other shared secret from the electronic device (step E150).

Some examples of decapsulation functions of the other encapsulation mechanism are described in the references cited above for the examples of the ephemeral public key and the ephemeral private key.

Typically, if the ephemeral public key and the ephemeral private key are ECIES keys as described in the document BSI TR-02102-1: BSI—Technical Guideline, version 2022-01, dated Jan. 28, 2022, https://www.bsi.bund.de/SharedDocs/Downloads/EN/BSI/Publications/TechGuidelines/TG 02102/BSI-TR-02102-1.pdf?_blob-publicationFile, the decapsulation function of the other encapsulation mechanism is as described in that document.

The method then comprises another step of obtaining the other derived key (step E170), during which the system 20 obtains the other derived key based on the other shared secret.

The other derived key is obtained by the system 20 in a manner similar to how it is obtained by the electronic device 10.

For example, when the electronic device obtains the other derived key by applying a key derivation function from the prior art to the other shared secret determined during the step of obtaining another shared secret and a corresponding cipher (step E120), the system computes the other derived key by applying this derivation function to the other shared secret determined during the step of obtaining the other shared secret (step E160).

The step of sending an ephemeral public key to the electronic device (step E100), the step of receiving the ephemeral public key from the system (step E110), the step of obtaining another shared secret and a corresponding cipher (step E120), the step of obtaining another derived key (step E130), the step of sending the cipher corresponding to the other shared secret to the system (step E140), the step of receiving the cipher corresponding to the other shared secret from the electronic device (step E150), the step of obtaining the other shared secret (step E160) and the other step of obtaining the other derived key (step E170) are typically implemented by the third module of the system 20 and the third module of the electronic device 10.

The third module of the system 20 may thus implement the step of sending an ephemeral public key to the electronic device (step E100), the step of receiving the cipher corresponding to the other shared secret from the electronic device (step E150), the step of obtaining the other shared secret (step E160) and the other step of obtaining the other derived key (step E170).

The third module of the electronic device 10 may implement the step of receiving the ephemeral public key from the system (step E110), the step of obtaining another shared secret and a corresponding cipher (step E120), the step of obtaining another derived key (step E130) and the step of sending the cipher corresponding to the other shared secret to the system (step E140).

In a step of sending a certificate to the system (step E401), the electronic device 10 sends the certificate of the public key to the system 20. During this step, the electronic device 10 sends a result of an encryption of a datum comprising the certificate of the public key with the other derived key to the system 20, typically using its communication unit 2.

In a step of receiving a certificate from the electronic device (step E411), the system 20 receives the certificate of the public key from the electronic device 10, typically using its communication unit 12.

During this step, the system 20 receives a cipher of the datum comprising the certificate of the public key from the electronic device 10, and decrypts a datum transmitted by the electronic device, that is to say said cipher of the datum comprising the certificate of the public key, with the other derived key.

The decryption operation executed here by the system 20 is in accordance with a cryptographic algorithm, for example AES, associated with the encryption operation executed by the electronic device 10 during the step of sending a certificate to the system (step E401).

The security of the mutual authentication method is thus enhanced.

The mutual authentication method makes it possible to ensure the confidentiality of the certificate of the public key sent by the electronic device to the system.

The method thus allows the electronic device and the system to ensure that the electronic device cannot be traced.

The method then comprises a certificate verification step identical to the other certificate verification step of the first mode of implementation (step E420).

The method then comprises a step of determining an authentication datum (step E500), a step of sending the authentication datum to the electronic device (step E510), a step of receiving the authentication datum (step E520), a step of computing a second authentication result (step E530), a step of sending the second authentication result to the system (step E540), a step of receiving a second authentication result from the electronic device (step E550) and a step of authenticating the electronic device (step E560) that are identical to those described for the first mode of implementation.

The step of sending a certificate to the system (step E401), the step of receiving a certificate from the electronic device (step E411), the certificate verification step (step E420), the step of determining an authentication datum (step E500), the step of sending the authentication datum to the electronic device (step E510), the step of receiving the authentication datum (step E520), the step of computing a second authentication result (step E530), the step of sending the second authentication result to the system (step E540), the step of receiving a second authentication result from the electronic device (step E550) and the step of authenticating the electronic device 10 (step E560) are in a phase of authenticating the electronic device (phase P2).

This phase of authenticating the electronic device is typically implemented by the second module of the system 20 and the second module of the electronic device 10.

The second module of the system 20 may thus implement the step of receiving a certificate from the electronic device (step E411), the certificate verification step (step E420), the step of determining an authentication datum (step E500), the step of sending the authentication datum to the electronic device (step E510), the step of receiving a second authentication result from the electronic device (step E550) and the step of authenticating the electronic device (step E560). The second module of the electronic device 10 may implement the step of sending a certificate to the system (step E401), the step of receiving the authentication datum (step E520), the step of computing a second authentication result (step E530) and the step of sending the second authentication result to the system (step E540).

In a step of sending a certificate to the electronic device (step E 201), the system 20 sends the certificate of the other public key to the electronic device 10. During this step, the system 20 sends a result of an encryption of a datum comprising the certificate of the other public key with the other derived key to the electronic device 10, typically using its communication unit 12.

In a step of receiving a certificate from the system (step E 211), the electronic device 10 receives the certificate of the other public key from the system 20, typically using its communication unit 2.

During this step, the electronic device 10 receives a cipher of the datum comprising the certificate of the other public key from the system 20, and decrypts a datum transmitted by the system, that is to say said cipher of the datum comprising the certificate of the other public key, with the other derived key.

The decryption operation executed here by the electronic device 10 is in accordance with a cryptographic algorithm, for example AES, associated with the encryption operation executed by the system 20 during the step of sending a certificate to the electronic device (step E201). This cryptographic algorithm is preferably the same as the one implemented during the step of sending a certificate to the system (step E401) and the step of receiving a certificate from the electronic device (step E411).

The security of the mutual authentication method is thus enhanced.

The mutual authentication method makes it possible to ensure the confidentiality of the certificate of the other public key sent by the system to the electronic device.

The method thus allows the electronic device and the system to ensure that the system cannot be traced.

The method then comprises another certificate verification step identical to the certificate verification step of the first mode of implementation (step E220).

The method then comprises a step of determining an authentication challenge (step E300), a step of sending the authentication challenge to the system (step E310), a step of receiving the authentication challenge from the electronic device (step E320), a step of computing a first authentication result (step E330), a step of sending the first authentication result to the electronic device (step E340), a step of receiving the first authentication result from the system (step E350) and a step of authenticating the system (step E360) that are identical to those described for the first mode of implementation.

The step of sending a certificate to the electronic device (step E201), the step of receiving a certificate from the system (step E211), the other certificate verification step (step E220), the step of determining an authentication challenge (step E300), the step of sending the authentication challenge to the system (step E310), the step of receiving the authentication challenge from the electronic device (step E320), the step of computing a first authentication result (step E330), the step of sending the first authentication result to the electronic device (step E340), the step of receiving the first authentication result from the system (step E350) and the step of authenticating the system (step E360) are in a phase of authenticating the system (phase P1).

This phase of authenticating the system is typically implemented by the first module of the system 20 and the first module of the electronic device 10.

The first module of the system 20 may thus implement the step of sending a certificate to the electronic device (step E201), the step of receiving the authentication challenge from the electronic device (step E320), the step of computing a first authentication result (step E330) and the step of sending the first authentication result to the electronic device (step E340).

The first module of the electronic device 10 may implement the step of receiving a certificate from the system (step E211), the other certificate verification step (step E220), the step of determining an authentication challenge (step E300), the step of sending the authentication challenge to the system (step E310), the step of receiving the first authentication result from the system (step E350) and the step of authenticating the system (step E360).

The method limits burdening of the resources of the electronic device.

The method implemented by the electronic device invokes a decapsulation function of a key encapsulation mechanism rather than a cryptographic signature function to authenticate the electronic device, and a cryptographic signature verification function rather than an encapsulation function of a key encapsulation mechanism to authenticate the system.

The method implemented by the system invokes a cryptographic signature function rather than a decapsulation function of a key encapsulation mechanism to authenticate the system, and an encapsulation function of a key encapsulation mechanism rather than a cryptographic signature verification function to authenticate the electronic device.

The method implemented by the system thus allows the electronic device to invoke a decapsulation function of a key encapsulation mechanism rather than a cryptographic signature function to authenticate the electronic device, and a cryptographic signature verification function rather than an encapsulation function of a key encapsulation mechanism to authenticate the system.

The security of the mutual authentication method is also enhanced.

This mutual authentication method makes it possible to ensure the confidentiality of the certificate of the public key sent by the electronic device to the system, and the confidentiality of the certificate of the other public key sent by the system to the electronic device.

The ephemeral public key allows the system to introduce a random element that forces the use of a new, other shared secret in each iteration of the method.

The application of the encapsulation function of the other key encapsulation mechanism allows the electronic device to introduce a random element that also forces the use of a new, other shared secret in each iteration of the method.

This method thus allows the electronic device and/or the system to ensure that the electronic device and the system cannot be traced.

It should be noted that burdening of the resources of the electronic device remains limited. The method implemented by the electronic device invokes the decapsulation function of the key encapsulation mechanism only once, and the encapsulation function of the other key encapsulation mechanism only once.

Lastly, the method limits exchanges between the electronic device and the system.

The method is particularly suitable for mutual authentication between the electronic device and the system in the context of synchronous communication between said electronic device and said system.

Thus, in one particular mode of implementation, each sending step (typically sending the cipher corresponding to the other shared secret to the system, sending the authentication challenge to the system, sending a certificate to the system and sending the second authentication result to the system) and each receiving step (typically receiving the ephemeral public key from the system, receiving a certificate from the system, receiving the first authentication result from the system and receiving the authentication datum) implemented by the electronic device comprises synchronous communication between the electronic device and the system.

In this particular mode of implementation, each sending step (typically sending an ephemeral public key to the electronic device, sending a certificate to the electronic device, sending the first authentication result to the electronic device and sending the authentication datum to the electronic device) and each receiving step (typically receiving the cipher corresponding to the other shared secret from the electronic device, receiving the authentication challenge from the electronic device, receiving a certificate from the electronic device and receiving a second authentication result from the electronic device) implemented by the system comprises synchronous communication between the electronic device and the system.

Each exchange between the electronic device 10 and the system 20 is thus direct and instantaneous.

The method then allows mutual authentication through synchronous communication while limiting the processing operations implemented by the electronic device.

Advantageously, a secure channel may be established based on the derived key for subsequent data exchanges between the electronic device and the system.

The method may then furthermore comprise a step of receiving, from the electronic device, or a step of sending, to the electronic device (neither shown), respectively a step of sending, to the system, and a step of receiving, from the system (neither shown), a datum that has been encrypted and/or authenticated, with at least one exchange key computed based on the derived key.

In another particular mode of implementation, the step (E340) of sending the first authentication result to the electronic device, and the step (E510) of sending the authentication datum to the electronic device, comprise encrypting the data to be sent with the other derived key.

During the step of sending the first authentication result to the electronic device (E340), the system 20 encrypts the first authentication result with the other derived key and then sends the cipher of the first authentication result to the electronic device 10.

During the step of sending the authentication datum to the electronic device (E510), the system 20 encrypts the authentication datum with the other derived key and then sends the cipher of the authentication datum to the electronic device 10.

The mutual authentication method thus makes it possible to ensure the confidentiality of other data transmitted by the system.

Typically, the mutual authentication method makes it possible to ensure the confidentiality of the first authentication result and of the authentication datum that are sent by the system to the electronic device.

In this other particular mode of implementation, the step of receiving the first authentication result from the system (step E350) and the step of receiving the authentication datum (step E520) comprise decrypting data transmitted by the system with the other derived key.

During the step of receiving the first authentication result from the system (step E350), the electronic device 10 receives the cipher of the first authentication result from the system 20 and then decrypts the cipher of the first authentication result with the other derived key so as to obtain the first authentication result.

During the step of receiving the authentication datum (step E520), the electronic device 10 receives the cipher of the authentication datum from the system 20 and then decrypts the cipher of the authentication datum with the other derived key so as to obtain the authentication datum.

These decryption operations executed by the electronic device 10 are in accordance with a cryptographic algorithm, for example AES, associated with the encryption operations executed by the system 20 during the step of sending the first authentication result to the electronic device (E340) and the step of sending the authentication datum to the electronic device (E510).

These encryption and decryption operations may be in accordance with the same cryptographic algorithm as the one used for the encryption and decryption operations in the step of sending a certificate to the system (step E401) and the step of receiving a certificate from the electronic device (step E411), and/or the step of sending a certificate to the electronic device (step E201) and the step of receiving a certificate from the system (step E211).

A person skilled in the art will understand that the steps of this method may be executed in other orders, provided that each step has the elements (for example the public key, the other public key, the authentication challenge, the first authentication result, the authentication datum or the second authentication result) needed for it to be executed.

The steps of this method may thus be executed in other orders, provided that
for each step implemented by the electronic device 10, said electronic device has the elements needed to execute the step in question, and
for each step implemented by the system 20, said system has the elements needed to execute the step in question.

According to a first example, the steps of the phase of authenticating the system (phase P1) may be executed before the steps of the phase of authenticating the electronic device (phase P2).

Typically, the step of sending a certificate to the electronic device (step E201), the step of receiving a certificate from the system (step E211), the other certificate verification step (step E220), the step of determining an authentication challenge (step E300), the step of sending the authentication challenge to the system (step E310), the step of receiving the authentication challenge from the electronic device (step E320), the step of computing a first authentication result (step E330), the step of sending the first authentication result to the electronic device (step E340), the step of receiving the first authentication result from the system (step E350) and the step of authenticating the system (step E360) may be executed, for example in that order, before the execution of the step of sending a certificate to the system (step E401), the step of receiving a certificate from the electronic device (step E411), the certificate verification step (step E420), the step of determining an authentication datum (step E500), the step of sending the authentication datum to the electronic device (step E510), the step of receiving the authentication datum (step E520), the step of computing a second authentication result (step E530), the step of sending the second authentication result to the system (step E540), the step of receiving a second authentication result from the electronic device (step E550) and the step of authenticating the electronic device 10 (step E 560), for example in that order.

According to a second example, the execution of the steps of the phase of authenticating the electronic device (phase P2) and the execution of the steps of the phase of authenticating the system (phase P1) may be interleaved, the phase of authenticating the electronic device and the phase of authenticating the system thus taking place concomitantly.

Typically, the steps of the method may be executed in the following order:
determining an authentication challenge (step E300), and then
sending a certificate to the system (step E400) and sending the authentication challenge to the system (step E310), and then
receiving a certificate from the electronic device (step E410) and receiving the authentication challenge from the electronic device (step E320), and then
carrying out certificate verification (step E420), and then
determining an authentication datum (step E500) and computing a first authentication result (step E330), and then
sending a certificate to the electronic device (step E200), sending the first authentication result to the electronic device (step E340) and sending the authentication datum to the electronic device (step E510), and then
receiving a certificate from the system (step E210), receiving the first authentication result from the system (step E350) and receiving the authentication datum (step E520), and then
carrying out certificate verification (step E220), and then
authenticating the system (step E360), and then
computing a second authentication result (step E530), and then
sending the second authentication result to the system (step E540), and then
receiving a second authentication result from the electronic device (step E550), and then
authenticating the electronic device (step E560).

According to a first advantageous option, the steps of sending a certificate to the system (step E401) and sending the authentication challenge to the system (step E310), respectively receiving a certificate from the electronic device (step E411) and receiving the authentication challenge from the electronic device (step E320), may be executed simultaneously by grouping the cipher of the certificate of the public key and the authentication challenge in a single message that is sent by the electronic device to the system.

According to a second advantageous option, the steps of sending a certificate to the electronic device (step E201) and sending the first authentication result to the electronic device (step E340) and sending the authentication datum to the electronic device (step E510), respectively receiving a certificate from the system (step E211) and receiving the first authentication result from the system (step E350) and receiving the authentication datum (step E520), may be executed simultaneously by grouping the cipher of the certificate of the other public key, the first authentication result (or its cipher) and the authentication datum (or its cipher) in a single other message that is sent by the system to the electronic device.

It should thus be noted that the datum comprising the certificate of the other public key may be for example the certificate of the other public key, or the result of a concatenation of the certificate of the other public key and the first authentication result, or the result of a concatenation of the certificate of the other public key and the authentication datum, or the result of a concatenation of the certificate of the other public key, the first authentication result and the authentication datum.

According to a third advantageous option, the authentication challenge is the cipher corresponding to the other shared secret or the cipher of the datum comprising the certificate of the public key.

It should be noted that the properties of the encapsulation function ensure that the other shared secret has a random value. The other shared secret is thus different in each iteration of the method. The cipher corresponding to the other shared secret and the cipher of the datum comprising the certificate of the public key are therefore also different in each iteration of the method.

With this third advantageous option, the step of obtaining another shared secret and a corresponding cipher (step E120) or the step of sending a certificate to the system (step E401) may be the step of determining an authentication challenge (step E300).

Furthermore, the step of sending the cipher corresponding to the other shared secret to the system (step E140) or the step of sending a certificate to the system (step E401) may be the step of sending the authentication challenge to the system (step E310).

Finally, the step of receiving the cipher corresponding to the other shared secret from the electronic device (step E150) or the step of receiving a certificate from the electronic device (step E411) may be the step of receiving the authentication challenge from the electronic device (step E320).

The method thus further limits burdening of the resources of the electronic device and the system and limits exchanges between the electronic device and the system.

The first module, the second module and the third module of the electronic device 10 may therefore cooperate to implement steps of the method.

Similarly, the first module, the second module and the third module of the system 20 may therefore cooperate to implement steps of the method.

According to a fourth advantageous option, in particular when the steps are ordered as described above for the second example, the reference datum may be the concatenation of the authentication datum (computed by the system during the step of determining an authentication datum) or its cipher, and the authentication challenge (received from the electronic device). The other reference datum is then the concatenation of the authentication datum (or its cipher) received from the system and the authentication challenge (determined by the electronic device and sent to the system).

The phase of authenticating the electronic device and the phase of authenticating the system are thus cryptographically linked. The security of the mutual authentication method is thus enhanced.

According to a fifth advantageous option, the step of sending the cipher corresponding to the other shared secret to the system (step E140) and the step of sending a certificate to the system (step E401), respectively the step of receiving the cipher corresponding to the other shared secret from the electronic device (step E150) and the step of receiving a certificate from the electronic device (step E411), may be executed simultaneously by grouping the cipher of the certificate of the public key and the cipher corresponding to the other shared secret in a single message that is sent by the electronic device to the system.

A person skilled in the art will also understand that some steps of this method may be omitted, provided that the other steps have the elements (for example integrity sums, arithmetic integrity sums and/or corrected integrity sums) needed to execute them.

1. A method for mutual authentication between an electronic device and a system the method being implemented by the electronic device, the electronic device having a private key associated with a public key, the system having another private key associated with another public key, and the method comprising:
i) a phase of authenticating the system, comprising the following steps:
determining an authentication challenge, and then
sending the authentication challenge to the system, and then
receiving a first authentication result from the system, and then
authenticating the system with the authentication challenge, the first authentication result and the other public key, and
ii) a phase of authenticating the electronic device, comprising the following steps:
receiving an authentication datum from the system, and then
computing a second authentication result on the basis of the authentication datum and the private key, and then
sending the second authentication result to the system, the method wherein:
the step of authenticating the system is carried out by applying a cryptographic signature verification function with the other public key to the first authentication result and to a reference datum comprising the authentication challenge,
the computing of the second authentication result uses a shared secret obtained by applying a decapsulation function of a key encapsulation mechanism to the private key and to the authentication datum.

2. The mutual authentication method as claimed in claim 1, wherein:
the authentication challenge is an anti-replay challenge, and
each sending step and each receiving step comprises synchronous communication between the electronic device and the system.

3. The mutual authentication method as claimed in claim 1, wherein the reference datum is the concatenation of the authentication datum and the authentication challenge.

4. The mutual authentication method as claimed in claim 1, wherein the phase of authenticating the system furthermore comprises the following steps:
receiving a certificate of the other public key from the system, and then
verifying the validity of the received certificate, and the phase of authenticating the electronic device furthermore comprises the following step:
sending a certificate of the public key to the system.

5. The mutual authentication method as claimed in claim 4, furthermore comprising the following steps:
receiving an ephemeral public key from the system,
obtaining another shared secret and a corresponding cipher, by applying an encapsulation function of another key encapsulation mechanism to the ephemeral public key,
obtaining another derived key based on the other shared secret,
sending the cipher corresponding to the other shared secret to the system, and wherein:
the step of sending a certificate of the public key to the system, sending a result of an encryption of a datum comprising the certificate of the public key with the other derived key to the system, and
the step of receiving a certificate of the other public key from the system comprises decrypting a datum transmitted by the system with the other derived key.

6. A method for mutual authentication between an electronic device and a system the method being implemented by the system, the electronic device having a private key associated with a public key, the system having another private key associated with another public key, and the method comprising:
i) a phase of authenticating the system, comprising the following steps:
receiving an authentication challenge from the electronic device, and then
computing a first authentication result on the basis of the authentication challenge and the other private key, and then
sending the first authentication result to the electronic device, and
ii) a phase of authenticating the electronic device, comprising the following steps:
determining an authentication datum, and then
sending the authentication datum to the electronic device, and then
receiving a second authentication result from the electronic device, and then
authenticating the electronic device with the second authentication result and the public key,
the method wherein
the first authentication result is computed by applying a cryptographic signature function with the other private key to a reference datum comprising the authentication challenge,
the authentication datum and a shared secret are determined by applying an encapsulation function of a key encapsulation mechanism to the public key,
the step of authenticating the electronic device uses the shared secret and the second authentication result.

7. The mutual authentication method as claimed in claim 6, wherein each sending step and each receiving step comprises synchronous communication between the electronic device and the system.

8. The mutual authentication method as claimed in claim 6, wherein the reference datum is the concatenation of the authentication datum and the authentication challenge.

9. The mutual authentication method as claimed in claim 6 wherein the phase of authenticating the system furthermore comprises the following step:
sending a certificate of the other public key to the electronic device, and the phase of authenticating the electronic device furthermore comprises the following steps:
receiving a certificate of the public key from the electronic device, and then
verifying the validity of the received certificate.

10. The mutual authentication method as claimed in claim 9, furthermore comprising the following steps:
sending an ephemeral public key associated with an ephemeral private key to the electronic device, and then
receiving a cipher corresponding to another shared secret from the electronic device,
obtaining the other shared secret by applying a decapsulation function of another key encapsulation mechanism to the ephemeral private key and to the received cipher,
obtaining another derived key based on the other shared secret, and wherein:
the step of receiving a certificate of the public key from the electronic device comprises decrypting a datum transmitted by the electronic device with the other derived key, and
the step of sending a certificate of the other public key to the electronic device comprises sending, to the electronic device, a result of an encryption, with the other derived key, of a datum comprising the certificate of the other public key.

11. The mutual authentication method as claimed in claim 10, wherein the step of sending the first authentication result to the electronic device, and the step of sending the authentication datum to the electronic device, comprise encrypting the data to be sent with the other derived key.

12. A computer program comprising instructions able to be executed by a processor and designed to implement a method as claimed in claim 1 when these instructions are executed by the processor.

13. A computer program comprising instructions able to be executed by a processor and designed to implement a method as claimed in claim 6 when these instructions are executed by the processor.

14. An electronic device comprising a memory storing a private key associated with a public key, the electronic device being designed to cooperate with a system having another private key associated with another public key, and the electronic device furthermore comprising:
i) a first module, configured to carry out a phase of authenticating the system that comprises the following steps:
determining an authentication challenge, and then
sending the authentication challenge to the system, and then
receiving a first authentication result from the system, and then
authenticating the system with the authentication challenge, the first authentication result and the other public key, and
ii) a second module, configured to carry out a phase of authenticating the electronic device that comprises the following steps:
receiving an authentication datum from the system, and then
computing a second authentication result on the basis of the authentication datum and the private key, and then
sending the second authentication result to the system,
the electronic device wherein:
the first module is configured to carry out the step of authenticating the system by applying a cryptographic signature verification function with the other public key to the first authentication result and to a reference datum comprising the authentication challenge,
the second module is configured to compute the second authentication result using a shared secret obtained by applying a decapsulation function of a key encapsulation mechanism to the private key and to the authentication datum.

15. A system designed to cooperate with an electronic device having a private key associated with a public key, the system comprising a memory storing another private key associated with another public key, and the system furthermore comprising:
i) a first module, configured to carry out a phase of authenticating the system that comprises the following steps:
receiving an authentication challenge from the electronic device, and then
computing a first authentication result on the basis of the authentication challenge and the other private key, and then
sending the first authentication result to the electronic device, and
ii) a second module, configured to carry out a phase of authenticating the electronic device that comprises the following steps:
determining an authentication datum, and then
sending the authentication datum to the electronic device, and then
receiving a second authentication result from the electronic device, and then
authenticating the electronic device with the second authentication result and the public key, the system wherein:
the first module is configured to compute the first authentication result by applying a cryptographic signature function with the other private key to a reference datum comprising the authentication challenge,
the second module is configured to determine the authentication datum and a shared secret by applying an encapsulation function of a key encapsulation mechanism to the public key, and to carry out the step of authenticating the electronic device using the shared secret and the second authentication result.
